(19) United States
(12) Patent Application Publication
(10) Pub. No.: US 2008/0181832 A1
(43) Pub. Date: Jul. 31, 2008

(54) POCKET-SIZE OZONE GENERATOR

(75) Inventors: Lih-Ren Shiue, Hsinchu (TW); Hsing-Chen Chung, Hsinchu (TW); Jen-Chieh Cheng, Hsinchu City (TW); Masami Goto, Tokyo (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: Lih-Ren Shiue, Hsinchu (TW)

(21) Appl. No.: 11/668,478

(22) Filed: Jan. 30, 2007

(51) Int. Cl. B01J 19/08; C01B 13/11

(52) U.S. Cl. 422/186.12

(57) ABSTRACT

A pocket-size ozone generator for in-situ sterilization of water is disclosed. The pocket-size ozone generator comprises a power source, at least a supercapacitor, a switching circuit and at least a pair of electrodes. The power source is adapted for providing a reaction energy to generate ozone gas within the water to be treated. The supercapacitor is adapted for amplifying the reaction energy provided by the power source. The circuitry is adapted for controlling the supercapacitor to deliver consistent power supply to generate ozone. The electrodes are adapted for receiving the amplified reaction energy from the supercapacitor to generate ozone within the water to be treated.

### BACKGROUND OF THE INVENTION

1. Field of the Invention

The present invention relates to water treatment. More specifically, the present invention relates to a DC power driven ozone generator suitable for performing in-situ disinfection and detoxification of potable water to render it safe to drink.

2. Background of the Related Art

Water is the most likely source of sickness for people living in the areas with poor or lack of sanitation, such as, wild lands, mountains, lakes, and particularly places hit by natural disasters, for example, earthquake, hurricane, flood or tsunami. Protozoan parasites including Giaradia muris cysts, or Cryptosporidium oocysts, or both can be found in 97% of the surface water in the US. The former microorganism may cause chronicle beaver fever, while the latter may lead to serious cholera-like gastroenteritis in people who drink the infested water. On the other hand, pathogens like Eecherichia Coli, Shigella and hepatitis A virus can easily be found in waters contaminated by animal fecal wastes and domestic wastewaters.

By far, chlorine is the most widely used disinfectant for killing the water-borne microorganisms in public water supplies around the world. In addition to the distinctive odor and the ineffectiveness of handling the protozoan, the chlorine treatment may generate carcinogens from the reaction of the chlorine with the organics present in the water. In December 2005, the US Environment Protection Agency (EPA) had issued a Purifier Protocol and Standard that prohibits “residues from the disinfectant used for sterilizing drinking water”. Under this guideline, ultraviolet (UV) and ozone (O₃) meet such standard as they are chemical-free disinfectants for purifying water. As a matter of fact, in Nice, France, ozone has been used to sterilize/disinfect the public water supply, since as early as 1906. Today, the UV irradiation process is included as one of the standard manufacturing processes in bottled-water and desalination plants. Ozone is listed as “Generally Recognized As Safe” (GRAS) for both potable and bottled water by the US Food and Drug Administration (FDA).

Electrolytic sterilization is a technique that uses an electric current to generate a disinfecting agent in water to serve as bactericide, virucide and or cyst inactivator. Among all chemicals, sodium chloride (NaCl) is the most popular precursor for making sodium hypochlorite (NaOCl) as the disinfectant as disclosed in the U.S. Pat. Nos. 3,622,479; 4,512,865 and 4,761,208. In the electrolytic detoxification, NaOCl is formed in electrochemical cells for removing ammonia (NH₃) from water as disclosed in U.S. Pat. Nos. 5,935,392 and 6,348,143. In all of the foregoing reactions, OCl⁻ ion is the oxidant adapted for sterilization or denitrification. Some of the ionic agents may survive the reactions and then become contaminants resulting in an increase of the TDS (Total Dissolved Solids) of the waters treated by OCl⁻. Many electrolytes specifically prepared to serve as the precursors for various agents formed electrolytically have been disclosed in numerous patents, for example, U.S. Pat. Nos. 5,531,883 and 5,997,702, just to name few. All in all, the chemicals added in the processes of electrolytic sterilization or electrolytic detoxification will become contaminants themselves, therefore leaving the treated water far from clean or safe.

Without adding any chemicals to the water to be treated, the sterilization of water is conducted through a direct electrolysis on sandwiched porous graphite electrodes as disclosed in U.S. Pat. No. 5,744,028, wherein the reaction current is too low to be effective. In U.S. Pat. No. 4,936,979, two alloy electrodes comprised of 88% copper (Cu), 10% tin (Sn) and 2% lead (Pb) are utilized electrolytic sterilization. The electrodes are consumed to provide 1 ppm (parts per million) Cu²⁺ for killing algae, as well as 0.5 ppt (parts per thousand) Sn²⁺ and 0.5 ppm Pb²⁺ for killing bacteria. The foregoing treatment may work for swimming pools, but it is incapable of eliminating the cyst contamination. Although ozone is a much more potent oxidant than OCl⁻, and applications of the gas are as versatile as from drinking-water sterilization, cleansing of semiconductor wafers as disclosed in U.S. Pat. No. 7,004,181, to medical treatments as disclosed in U.S. Pat. Nos. 5,834,030 and 6,902,670, nevertheless, the oxidizing gas is overwhelmingly generated by corona discharge. The silent discharge method has many problems, for example, a high working voltage, oxygen provision, gas leakage and ozone dissolution. Not only are the foregoing disadvantages absent from the electrolytic generation of ozone, but unique advantages are also present in the in-situ method as elaborated in U.S. Pat. No. 6,984,295. Without chemicals or electricity, ozone is produced via the absorption of 185 nm UV by oxygen as disclosed in U.S. Pat. No. 4,230,571. Recently, UV sterilizers have been fabricated into a hand-held device size for onsite sterilization of potable water. Compared to the aforementioned bulky electrolytic cells, the mini-size UV sterilizer is user-friendly, but the UV lamp is vulnerable to damage under external force.

Accordingly, the present invention provides a robust, chemical-free and compact ozone generator capable of being battery operated suitable for sterilizing/disinfecting and detoxifying potable waters.

### SUMMARY OF THE INVENTION

The present invention is directed to a pocket-size ozone generator that can be immersed in water for in-situ sterilization/disinfection of water. The pocket size ozone generator may be driven by DC power, and is capable of generating ozone from within water at any point of use. In order to prolong the service life of the ozone generator, a durable and foul-free electrode is used for generating ozone.

An alkaline battery or rechargeable battery may serve as the main power source for driving the ozone generator to perform electrolysis on water to generate ozone. To minimize the size of the ozone generator, only a few batteries are required. Since the batteries can only deliver a small current, a supercapacitor is adapted to supplement the power deficiency of the battery. In addition, the supercapacitor can also extend the use-time of battery through the “load leveling” effect. Furthermore, two identical groups of supercapacitors are arranged to discharge and re-charge alternatively through a charging-discharging swing, or CD swing approach, so that the power delivered to the electrolysis reaction can be continuous and consistent.

Among the electrode materials available for ozone generation, platinum (Pt) or conducting diamond film (boron-doped diamond, BDD) may be selected for the sake of safety and hygiene. The decay of the foregoing electrode materials does not generate hazardous ingredients into the treated potable water. A plastic screen is disposed between the anode and cathode, which are symmetrical in shape and identical in composition, of the ozone generator to prevent an electrical short. The two electrodes and the plastic screen are fastened together. The electrode is easy to clean and maintain, and can be easily replaced. The ozone generator can also be used as a stirrer during treatment to ensure that all of the water is sterilized or detoxified. No air is required to be injected into the water during the treatment process, ozone is formed due to ionization of the water.

The surface area of the electrodes, the discharge rate of the battery, the capacitance of the supercapacitor, as well as the conductivity of the water to be treated collectively determine the concentration of ozone produced. Generally, the amount of ozone generated is sufficient for sterilization/disinfection of the water but safe for the users to drink. The sterilization time usually ranges around 30-60 seconds, and can kill most of the microbes contained in the water. The ozone generator may be equipped with a switch that can be used to operate the ozone generator for any desired preset time.

### BRIEF DESCRIPTION OF THE DRAWINGS

The present invention is best understood by reference to the embodiments described in the subsequent sections accompanied with the following drawings.

FIG. 1 is a schematic diagram of a pocket-size ozone generator showing the major components according to an embodiment of the present invention.

FIG. 2 is a circuit diagram for performing the charging-discharging swing on two groups of supercapacitors using relays as switching mechanism according to an embodiment of the present invention.

FIG. 3 is a circuit diagram for performing charging-discharging swing on two groups of supercapacitors using MOSFETs as switching mechanism according to another embodiment of the present invention

FIG. 4 is a view of electrodes suitable for the ozone generator according to an embodiment of the present invention.

### DETAILED DESCRIPTION OF THE INVENTION AND BEST MODES

The preferred embodiments of the pocket-size ozone generator of the present invention are presented as follows.

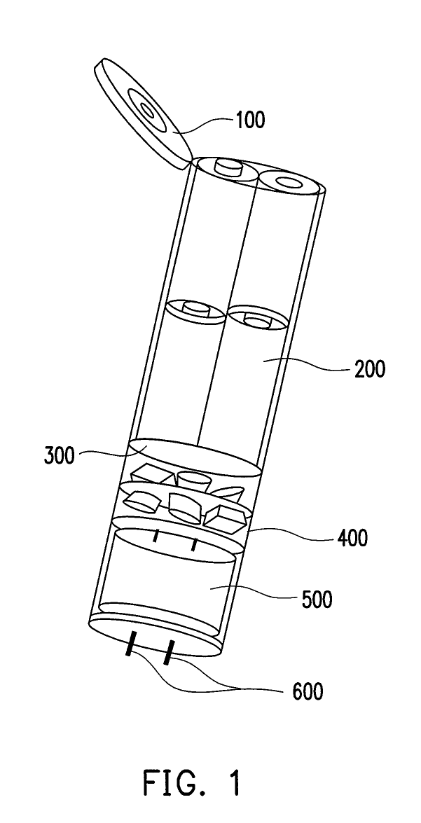

FIG. 1 shows the schematic configuration of a hand-held pocket-size ozone generator that can perform in-situ sterilization or detoxification of waters at any point of use. As shown in FIG. 1, the generator comprises of a battery compartment 100 with a lid 100, an IC board 400 and a pair of electrodes 600. The primary and the secondary batteries 200 inside the battery compartment are adapted for charging the supercapacitor and the IC board is adapted for controlling the charging of supercapacitor. Both of the primary battery and secondary battery serve as the main power source for providing power to the supercapacitors 500 which amplify the power to a sufficient level to rapidly produce ozone. The operating voltage and the discharge rate of the batteries 200 are important factors, which depend on the chemistry inside the battery 200. For an alkaline battery, the so called primary or non-rechargeable battery, every unit cell can deliver a working voltage of 1.5V at a rated capacity ranging from 1.1 to 17 Ah, depending on the battery size. Nevertheless, the practical Ah capacity is determined by the discharge rate of battery, that is, the discharge current. The rated Ah capacity is realizable when the battery is discharged at 25 mA or lower. Though a low discharge rate of an alkaline battery is disadvantageous for rapid sterilization, the battery is widely available and it can be put to use without the need of charging. On the other hand, the secondary or re-chargeable batteries can be discharged at a rate one fold higher than the alkaline battery. Their working voltage also varies greatly, for example, the nickel metal hydride (Ni-MH) is 1.2V and the lithium ion (Li⁺) battery is 3.6V. Using a higher voltage Li⁺ battery as the potential source allows for the pen-like O₃ generator to use 3-time less batteries compared to Ni-MH. However, all rechargeable batteries need a specific charger, and the batteries are limited in availability except in populated areas.

In order to produce a sufficient and safe amount of ozone, the maximum operating power for the ozone generator to perform in-situ and rapid sterilization of water is designed at 6 W. Considering the variation of water conductivity from miscellaneous water sources, the operating voltage of the ozone generator is set at 6V. Accordingly, the operating current should be 1 A to deliver the required 6 W power. The targeted current is beyond the allowable or optimal discharge rate of primary batteries and secondary batteries alike. Conventionally, a step-up circuit using DC/DC converter is used for producing high currents from low-current inputs of batteries. Such a converter is often bulky and costly, and therefore not suitable for the pocket size ozone generator shown in FIG. 1. A better approach is to employ a supercapacitor as a charge pump for the battery on the power provision for the ozone generation. Not only does the supercapacitor 500 store electrical energy just like the ordinary capacitors, but it also stores an amount of energy that is much more convertible to current outputs by many folds above that of the discharge currents of batteries 200. By simply connecting the battery 200 and the supercapacitor 500 in series or in parallel, the latter will be charged quickly to the voltage of the former. Thus, the supercapacitor 500 will deliver large currents for the battery 200 to meet the power demands, which results in a “load leveling effect”. Nevertheless, all capacitors are unable to continuously and consistently deliver power as batteries do for the energy content of capacitors is relatively low. Not only there is an idle period, or inconsistent power provision with using the capacitors, but there is also a significant waste of the stored energy of capacitors. Even though the wasted energy is ineffective to perform, it occupies a higher portion of the energy storage of capacitors than the effective energy. Henceforth, a control mechanism is needed to effectively utilize the supercapacitor's energy that is provided by batteries or other potential sources.

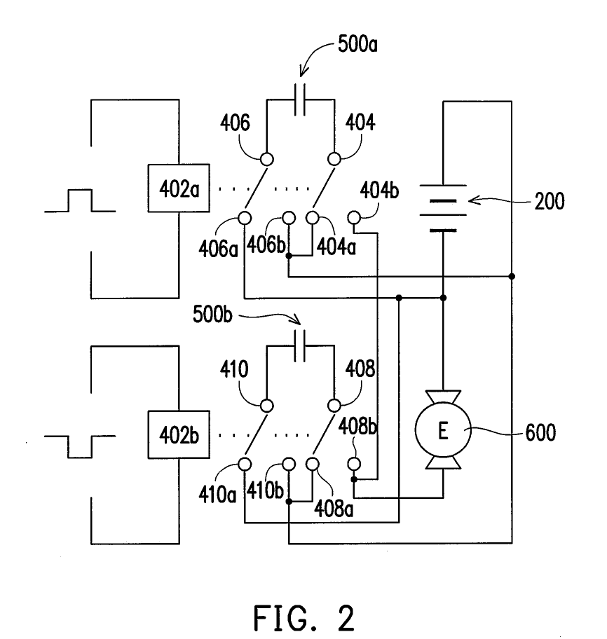

FIG. 2 shows a circuitry adapted for making the supercapacitors highly efficient to deliver consistent power. This circuit is depicted as 400 in FIG. 1. As shown in FIG. 2, the circuit is comprised of two supercapacitors 500a and 500b, each comprising two sets terminals 404 and 406, and 408 and 410, respectively. The supercapacitors 500a and 500b can be reciprocally switched between charging and discharging states, which is also known as CD swing, controlled by two relays 402a and 402b. Each relay is a double-pole double-throw (DPDT) mechanical switching device. At the initiation of CD swing, the two relays 402a and 402b are at the normally closed state as shown in FIG. 2, and two groups of supercapacitors 500a and 500b are charged in parallel by battery 200. The flow paths of the charging current in-and-out of the supercapacitors 500a and 500b are shown as follows:

Supercapacitor 500a: (+) pole of 200→404a→404→406→406a→(−) pole of 200

Supercapacitor 500b: (+) pole of 200→408a→408→410→410a→(−) pole of 200

Initially, the terminals of the supercapacitors 500a and 500b carry no polarity before charging. As the supercapacitors 500a and 500b are charged, their terminals will have the same polarity as that of the battery 200. That is, terminals 404 and 406 will serve as the positive and negative electrodes of the supercapacitor 500a, and the terminals 408 and 410 serve as the positive and negative electrodes of the supercapacitor 500b, respectively. The CD swing is initiated by depressing the latch button (not shown), an audible clicking sound is indicative of the switching of the relays 402a and 402b between “closed” and “open” states leading to the switching of the supercapacitors 500a and 500b between charging and discharging states. The operation procedure of the CD swing may be described as follows. The operation procedure of the CD swing includes at least a first cycle, a second cycle and a third cycle.

The First Cycle.

The relay 402a is switched “on” (“open” state) and the relay 402b remains at “closed” state (i.e. “off” state). Meanwhile, the relay 402a changes the contact points of two terminals 404 and 406 of the supercapacitor 500a from 406a/404a to 406b/404b. Thus, the (+) terminal 404 of the supercapacitor 500a is in electrical contact with the two electrodes 600, whereas the supercapacitor 500b remains in parallel with the battery 200. Since the supercapacitor 500b is charged, the battery 200 is prevented from charging the supercapacitor 500b. However, the supercapacitor 500b is also connected in series with the supercapacitor 500a (408→408a→406b→406), the supercapacitors 500a and 500b deliver at the combining voltages of the supercapacitors 500a and 500b, or two times voltage of 200, to the electrodes 600 through (+) pole 404 of the supercapacitor 500a. If the super capacitor 500b releases some of its stored energy, it will be promptly replenished by the battery 200 so that the supercapacitor 500b remains charged ready for assuming the role of discharge.

The Second Cycle.

The relay 402a is “off” (“closed” state) and the relay 402b is “on” (i.e. “open” state). The supercapacitor 500a is connected in parallel with the battery 200 for recharging the energy released in the prior discharging cycle. The contact points of terminals 408 and 410 of the supercapacitor 500b are switched from terminals 408a/410a to 408b/410b. Hence, the supercapacitor 500b will deliver an electric power to the electrodes 600 in conjunction with the supercapacitor 500a. Meanwhile, the supercapacitor 500a is replenished by the battery 200 via their parallel connection.

The Third Cycle and Beyond.

The third cycle includes flow of the first cycle and the second cycle being alternately repeated for every odd-cycle and every even-cycle of CD swing respectively to provide a consistent power supply to the electrodes 600 until the preset sterilization time period has reached (until latch button is turned off) to complete the sterilization.

In the CD swing technique as described above, two identical sets of supercapacitor are employed to reciprocally switch between charging and discharging for continuously supplying consistent power to the electrodes 600 to rapidly generate ozone that is several folds more effective than many other widely used disinfecting chemicals, such as chlorine, chlorine oxide or chloroamines. According to Jensen in “Ozone: The Alternative for Clean Dialysis Water” (DIALYSIS & TRANSPLANTATION, Volume 27, Number 11, pp 708-712, November 1998), the concentration-time value ranges (expressed as mg/L-min) for 99% inactivation of various organisms by O₃ at 5° C. is about 0.006-2.0 ppm-min. Thus, an operating voltage of 6V is sufficient to drive ozone generator of the present invention to generate the sufficient amount of O₃. For example, about 1 A of operating current and about 0.5 F capacitance for each of the supercapacitors 500a and 500b are required for the compact ozone generator to produce sufficient amount of ozone in about 30-60 seconds. Nevertheless, with the 5V driving-voltage threshold of the relays 402a and 402b, 4 pieces of alkaline batteries are required. Other power sources, for example, rechargeable batteries, fuel cells or solar cells, can also be used for driving the ozone generator of the present invention. Different power sources deliver different voltage outputs, and accordingly the design of the power compartment of the ozone generator should be varied. Regardless of the power source, the power can be amplified by the supercapacitors 500a and 500b and the relay-operated circuit. The relays 402a and 402b have a low-frequency, about 6 cycles per second (6 Hz), mechanically switching devices, and the low frequency will lead to a large fluctuation of output voltage for the power sources using the CD swing. Other disadvantages of the CD swing technique using a relay mat include mechanical wearing due to numerous times of switching, and a fusion of the relay contacts from an excessive current flow through the relay. However, since the ozone generator of the present invention consume significantly less power and has a low-switching operation, the relays can work well for rapid in-situ sterilization of potable waters.

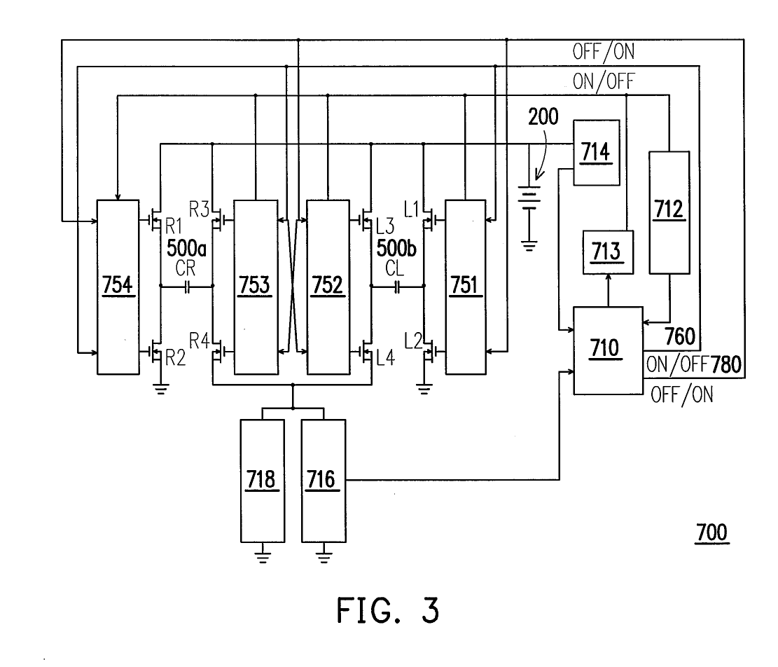

FIG. 3 shows the switching circuitry 700 for the CD swing technique using MOSFET (metal oxide semiconductor, field emission transistor) as the switching device according to a second preferred embodiment of the present invention. With fast response time and no moving parts, the MOS-FET can eliminate the low switching frequency and mechanical wearing problems of the relay. Nonetheless, the use of MOSFET is comparatively more complicated and expensive. Referring to FIG. 3, the power source for the pocket-size ozone generator includes a battery for supplying power to the two identical sets of supercapacitors 500a and 500b operating in the CD swing technique. The controller 710 will conduct the CD swing of the supercapacitors 500a and 500b, based on the feedback of voltage sensor 712, via two data buses 760 and 780. The latter will send the instructions of the controller 710 to the switching circuitries of MOS-FETs 751, 752, 753 and 754. The ON/OFF instructions transmitted via data buses 760 and 780 are opposite to each other at all times, that is, when the bus 760 is ON, the bus 780 is OFF, and vice versa. In order to provide a stable operating-voltage for the switching circuitries 751 to 754, their power supply is managed by a step-up circuitry 713, a voltage stabilizer 714, and a bus 770. Each of the supercapacitors 500a and 500b has four (4) separate sets of MOS-FETs L1-L4 and MOS-FETs R1-R4, respectively. For the convenience of controlling FET by a positive pulse voltage, N-type FET is used to control the charging and discharging swing of the supercapacitors 500a and 500b. Contrarily, P-type FET is controlled by a negative pulse voltage that is inconveniently generated.

Before the initiation of charging-discharging process, the MOS-FETs L2 and L3 of the supercapacitor 500b are in the “closed” state, the MOS-FETs L1 and L4 of the supercapacitor 500a are in the “open” state, and the MOS-FETs R2 and R3 of the supercapacitor 500a are in the “closed” state and the MOS-FETs R1 and R4 are in the “open” state. Therefore, the supercapacitors 500a and 500b are connected in parallel with battery B, and the supercapacitors CL and CR are charged simultaneously to the same voltage and polarity of 200. Once the CD swing is initiated, the process will be conducted as follows:

The First Cycle

The supercapacitor 500a is in parallel with the battery 200, MOS-FETs L1 and L4 are in the “closed” state and MOS-FETs L2 and L3 of the supercapacitor 500b are in the “open” state. As a result, the supercapacitor 500b and the battery 200 are connected in series, thus, they discharge collectively to the load 718, or the electrodes of the ozone generator. The current delivered to load 718 is monitored by the current sensor 716 so that the power supplied to the ozone generator can be set at a desired level.

The Second Cycle.

The supercapacitor 500b is switched to the parallel configuration with the battery 200 (i.e. the MOS-FETs L2 and L3 are in the “closed” state, and the MOS-FETs L1 and L4 are in the “open” state), thus, the partially discharged supercapacitor 500b is replenished by the battery 200. Meanwhile, the supercapacitor 500a is switched into series connection with the battery 200 (i.e. MOS-FETs R1 and R4 are in the “closed” state, and MOS-FETs R2 and R3 are in the “open” state), thus, the supercapacitor 500a and the battery 200 discharge collectively to load 718 to generate ozone.

The Third Cycle and Beyond.

The third cycle, the first cycle and the second cycle, described above, that are repeated alternatively for every odd-cycle and every even-cycle furthering a CD swing technique, respectively, to provide a consistent power to the electrodes of the ozone generator of the present invention until the preset sterilization period has reached (i.e. until the latch button is depressed off) to complete the sterilization of the potable waters.

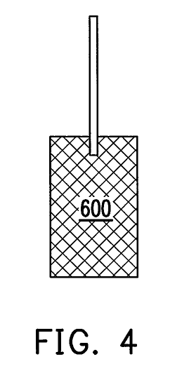

FIG. 4 shows a view of a structure of the electrodes 600 of the ozone generator according to an embodiment of the present invention. The electrodes are comprised of screen electrodes, each having a width of about 2.5 cm and a height of about 4 cm. A plastic 1 mm spacer (not shown) is interposed between the electrodes. The electrodes may be comprised of “platinum (Pt) or conductive highly boron-doped diamond (BDD) material coated titanium (Ti) meshes. A Ti rod of 2.4 mm diameter is welded to each screen electrode to electrically connect them to the power source. The electrodes and the plastic spacer may be fastened together by a plastic or an insulating strap into a replaceable electrode set. For a low cost and long-term use, no permeable membrane should be included in the electrodes 600 shown in FIG. 4 for treating waters of high hardness. The high hardness is due to high amounts of magnesium and calcium ions present in the waters, and the ions are prone to form fine precipitates to clog the membrane. Nevertheless, when a proton-exchange membrane is disposed between the electrodes 600 shown in FIG. 4, the ozone output is higher than that yielded by the electrodes without the membrane. Henceforth, a proton-exchange membrane is integrated with the electrodes 600 shown in FIG. 4 for the pen-like ozone generators intended for sterilizing tap water or other freshwaters with hardness no greater than 200 ppm.

Batteries 200 with higher discharge rate than the alkaline batteries, for example, lithium ion battery, are employed with the electrodes shown in FIG. 4 to form ozone without the supercapacitors and the CD swing circuit. Ozone is also detected within a tap water treated by only the power of the batteries 600, however, the ozone generated is significantly lower than the output of the ozonators assisted by the supercapacitors. The pen-like ozone generator of the present invention has many selections on the power source. In addition to the batteries 600, human-powered generator and renewable energies can work as the potential source for the compact ozonators to perform the sterilization as well. A preferred embodiment is a detachable power source and a main O₃-generating body containing electrodes 600 shown in FIG. 4 integrated with the CD swing circuit and built-in supercapacitors. Inside the main body, there are two kinds of supercapacitors 500, one has large capacitance, for example, 5V and 6 F or higher, to serve as an energy reservoir and the other is two groups of supercapacitors with 10-time lower capacitance, 0.6 F each, to discharge by the control of the CD swing circuit. Moreover, the main body has a power input socket for the electrical leads of the detachable power source to plug in. Renewable energy devices, such as, solar panels or micro wind turbines, can harness energy from the environments to charge the supercapacitor reservoir, which in turn delivers power to the smaller capacitors to discharge to generate ozone. Similarly, the human power is applied to a moving-coil resonant type liner generator to generate electricity through Faraday's law for charging the supercapacitor reservoir. The combinatory techniques of electromagnetic induction and supercapacitor for lighting, communication and entertainments are seen in U.S. Pat. Nos. 6,034,492, 6,217,398, 6,220,719 and 6,291,900. There is no similar application for the sterilization of waters yet. The mechanical motion required to generate electricity can be provided by hand shaking, hand or foot cranking. With the human-powered generator, the pocket-size ozone generator of the present invention may be used in areas where batteries are not affordable.

### EXAMPLE

A prototype ozone generator as shown in FIG. 1 may be manufactured using a pair of Pt-coated Ti mesh electrodes having the dimensions and configuration as depicted in FIG. 4. Four pieces of AA-size alkaline batteries are connected in series to form a 6V×2.78 Ah pack as the power source for providing electric energy to the two 5V×0.5 F supercapacitors. A switching circuit as shown in FIG. 2 is disposed between the batteries and the supercapacitors for managing the energy transfer between the two, as well as the charging and discharging swing of the supercapacitors. Once the CD swing is in operation, the power module composed of [batteries+switching circuit+supercapacitors] will output a voltage of about 11V DC. The aforementioned ozone generator was employed to perform in-situ sterilization on waters from two different sources, namely a faucet and a roadside ditch. Rather than the assessment of the inactivation of particular bacteria, the total quantity of bacteria killed in the waters was analyzed. The sterilization analysis was conducted by transferring 1 ml of untreated or treated water onto an aerobic count plate (Petrifilm™ from 3M, Saint Paul, Minn., USA), the bacteria count (expressed in cfu or colony forming unit per milliliter) after incubation at 36° C. for 68 hours was calculated. The test results are listed in Table 1.

TABLE 1
In-Situ Sterilization of Tap Water and Ditch Water
By a Pocket-Size Ozone Generator

Water Samples

| | Tap Water | Ditch Water |
|---|---|---|
| Water Volume Treated (ml) | 200 | 200 |
| Sterilization Current (A) | 0.6 | 0.8 |
| Reaction Time (min) | 1 | 1 |
| Initial Bacteria Count (cfu/ml) | 600 | 840 |
| Post Bacteria Count (cfu/ml) | 2 | 5 |
| % of Bacteria Inactivated | 99.7 | 99.4 |

During the sterilization treatment, the water was stirred by the ozone generator. Water from roadside ditch was more contaminated than that from the faucet, therefore, the former consumed more energy to accomplish sterilization. In both cases, as can be inferred from the table above, the waters were effectively sterilized and disinfected.

### CONCLUSION

As it can clearly be seen from the above example and other in-house tests, the compact pocket sized ozone generator provided by the present invention can effectively perform in-situ sterilization of waters, and can easily be carried by the tourists traveling to places without adequate sanitation facilities. A tune of 99% inactivation of microbial and hazardous contaminants present in the potable waters can be achieved in just 30-60 seconds of treatment. The hand-held pocket size ozone generator can be operated by batteries, human power and renewable energies, and it requires no addition of chemicals to the water to be treated. After treatment, the ozone will be converted to oxygen without forming any residues in the treated waters. The amount of ozone is sufficient for sterilization and at a level that is harmless to the users. Thus, no chemicals are required to generate ozone, and the ozone generator only requires the replacement of spent batteries, while the electrodes and human-powered generator may be used a long-period of time.

What is claimed is:

1. A pocket-size ozone generator for in-situ sterilization of water, comprising:
a power source, for providing a reaction energy to generate ozone gas within water to be treated;
at least one supercapacitor, for amplifying the reaction energy provided by said power source;
a circuitry, for controlling said supercapacitor to deliver consistent power supply to generate ozone; and
at least a pair of electrodes, for receiving the amplified reaction energy from said supercapacitor for generating ozone within the water to be treated.

2. The pocket-size ozone generator as claimed in claim 1, wherein the power source is selected from a group consisting of primary batteries, secondary batteries, fuel cells and solar cells.

3. The pocket-size ozone generator as claimed in claim 1, wherein the supercapacitor has an operating voltage of at least 2.5V, and at a capacitance of at least 0.5 F.

4. The pocket-size ozone generator as claimed in claim 1, wherein the control circuit switches at least two identical supercapacitors operated between charging and discharging states.

5. The pocket-size ozone generator as claimed in claim 4, wherein the switching device comprises a relay or a MOS-FET (metal oxide semiconductor, field effect transistor).

6. The pocket-size ozone generator as claimed in claim 4, wherein the switching frequency comprises 6 cycles per second or above.

7. The pocket-size ozone generator as claimed in claim 1, wherein the electrodes have a shape of mesh, screen, or wire network.

8. The pocket-size ozone generator as claimed in claim 7, wherein the electrodes comprises platinum or boron doped diamond.

9. A pocket-size ozone generator for in-situ sterilization of water, comprising:
a human-powered generator, for providing energy to generate ozone gas within water to be treated;
a first supercapacitor, for storing the energy generated by the said generator;
at least a second supercapacitor, having a smaller capacitance compared to the first supercapacitor, for amplifying energy provided by a power source;
a circuitry, for controlling said first supercapacitor to deliver consistent power supply to generate ozone; and
at least a pair of electrodes, for receiving the amplified energy from said first supercapacitor for generating ozone within the water to be treated.

10. The pocket-size ozone generator as claimed in claim 9, wherein the generator produces electricity through electromagnetic induction.

11. The pocket-size ozone generator as claimed in claim 9, where the supercapacitor has a capacitance of at least 6 F.
